(19) United States
(12) Patent Application Publication
(10) Pub. No.: US 2004/0186735 A1
(43) Pub. Date: Sep. 23, 2004

(54) Encoder programmed to add a data payload to a compressed digital audio frame

(76) Inventors: Gavin Robert Ferris, London (GB); Alessio Pietro Calcagno, London (GB)

Correspondence Address: Richard C Woodbridge, Synnestvedt Lechner & Woodbridge, P O Box 592, Princeton, NJ, 08542-0592, US

(21) Appl. No.: 10/486,949

(22) PCT Filed: Aug. 13, 2002
(86) PCT No.: PCT/GB02/03696

(30) Foreign Application Priority Data
Aug. 13, 2001 (GB) 0119569.2

(51) Int. Cl. G10L 19/00

(52) U.S. Cl. 704/500

(57) ABSTRACT

An MPEG 1 layer II encoder can be programmed to add a data payload to a frame. It uses a conventional Musicam pyshoacoustic model to apply a sub-band resolution parameter that is constant across a window of a given number of samples. The encoder is further programmed to apply a sub-band resolution algorithm that generates a more accurate set of resolution parameters that vary across at least part of a given window, the difference between the constant parameter and the variable resolution parameters for the same window being indicative of bits which can be overwritten with the data payload.

### FIELD OF THE INVENTION

This invention relates to an encoder programmed to add a data payload to a compressed digital audio frame. It finds particular application in DAB (Digital Audio Broadcasting) systems.

### DESCRIPTION OF THE PRIOR ART

The Eureka-147 digital audio broadcasting (DAB) system, as described in European Standard (Telecommunications Series), Radio Broadcasting Systems; Digital Audio Broadcasting (DAB) to Mobile, Portable and Fixed Receivers, ETS 300 401, provides a flexible mechanism for broadcasting multiple audio and data subchannels, multiplexed together into a single air-interface channel of approximately 1.55 MHz bandwidth, with encoding using DQPSK/COFDM.. A number of transmission systems utilising DAB are successfully broadcasting in the UK and throughout Europe.

Recent years have seen a vast increase in the amount of data being sent worldwide (estimates place Internet traffic growth, for example, at around 800% pa), and there is demand for much of this traffic to be sent wirelessly. There is a significant class of such data (e.g., news, stock quotes, traffic information, etc.) for which broadcast would be a suitable distribution mechanism.

However, while DAB can transmit ‘in band’ data subchannels (whether in stream or packet mode), the amount of spectrum is limited, and in many cases has already been allocated to services. Therefore, it would be advantageous to have a mechanism of effectively extending the data capacity of the DAB system, without perturbing any of the existing services or receivers, and without modification of the spectral properties of the air waveform.

Reference may be made to WO 00/07303 (British Broadcasting Corporation) which shows a system for inserting auxiliary data into an audio stream. However, the auxiliary data is inserted not into a compressed digital audio frame, but instead PCM samples. This prior art hence does not deal with the problem of the present invention, namely increasing the data payload of a compressed digital audio frame.

### SUMMARY OF THE PRESENT INVENTION

In a first aspect of the present invention, there is an encoder programmed to add a data payload to a compressed digital audio frame, in which parameters that determine the resolution of frame sub-band samples are constant across a window of a given number of samples but may be different for adjacent windows;

characterised in that the encoder is further programmed to apply a sub-band resolution algorithm that generates a more accurate set of resolution parameters that vary across at least part of a given window, the difference between the constant parameter and the variable resolution parameters for the same window being indicative of bits which can be overwritten with the data payload.

The present invention proposes the use of a particular form of data hiding (steganography). The system exploits the fact that the existing DAB audio codec (MPEG 1 layer 2, also known as Musicam) is sub-optimal in terms of attained compression and redundancy removal.

This fact allows a steganographic encoder designed according to the present invention to analyse a ‘raw’ Musicam frame, determine to a sufficient degree of accuracy the ‘unnecessary’ or redundant bits by using a sub-band resolution algorithm that generates a more accurate set of resolution parameters that vary across at least part of a given window, the difference between the constant parameter (generated by the Musicam PAM—psychoacoustic model) and the variable resolution parameters for the same window being indicative of the unnecessary bits. The encoder can then write the desired payload message over these bits (taking care to ensure that e.g. the frame CRCs are recomputed as may be necessary).

It should be noted that the present invention is an ‘encoder’ in the sense that it can encode a data payload; the term ‘encoder’ does not imply that compression has to be performed, although in practice the present invention can be used together with an encoder such as a Musicam encoder which does compress PCM samples to digital audio frames.

Since the information overwritten is, by definition, redundant, the output (and still valid) Musicam frame will be indiscernible, when decoded, from the original to an average human listener, even though it now contains the extra ‘hidden’ information. An appropriately constructed receiver, on the other hand, will also be able to detect the presence of this hidden data, extract it, and then present the stream to user software through an appropriate interface service access point (SAP).

Although the concept of steganography per se is known in the prior art, the invention described herein has significant novelty. The system described exploits specific features of the MPEG audio coding system (as used in DAB). The MPEG system assumes that certain audio parameters may be held constant for fixed increments of time (e.g., the “resolution” (as that term is defined in this specification) of a frequency band sample for an 8 ms audio frame). The steganographic system described here exploits this ‘persistent parameterisation’ assumption (which does not in the general case mirror reality in the underlying audio), and exploits the redundancy so produced in the coded MPEG audio frames to carry payload data.

Adding data to a DAB frame is known, but only for non-steganographic systems, such as inserting the data into part of the frame (the ‘ancillary data part’) which is not used either for the actual media data which is to be uncompressed or for the data needed for the correct uncompression. One common application of this approach is for Programme Associated Data (PAD). However, there are many circumstances in which simply adding data to a part of the frame in an open manner is inappropriate—for example, where the additional data needs to be hidden because it relates to digital rights management information which, if subverted, could lead to unauthorised actions, such as copying a media file which is meant to be copy protected. Further, capacity in auxiliary data parts may be fully utilised, making it highly attractive to be able to hide data in the voice/music coding parts of a frame, as it is possible to do with the present invention.

In a second aspect, there is a decoder programmed to extract a data payload from a compressed digital audio frame, which has been added to the frame with the encoder of claim 1, in which the decoder is programmed to apply an algorithm to identify the bits containing the payload, the algorithm being the same as the sub-band resolution algorithm applied by the encoder.

Further details of the invention are given in the attached claims.

### BRIEF DESCRIPTION OF THE DRAWINGS

The present invention will be described with reference to the accompanying drawings, in which:

FIG. 1 is the Human Auditory Response Curve;

FIG. 2 shows Simultaneous Masking Due To A Tone;

FIG. 3 shows Various Forms of Masking (Due To e.g. Percussion);

FIG. 4 shows MPEG Audio Encoding Modes;

FIG. 5 shows a Conceptual Model of a Psychoacoustical Audio Coder;

FIG. 6 shows a MPEG-1 Layer 1 Encoder;

FIG. 7 shows a MPEG-1 Layer 2 Encoder;

FIG. 8 shows a MPEG Frame Format (Conceptual);

FIG. 9 shows Specialization of MPEG Frame Structure for E-147 DAB;

FIG. 10 shows a Steganographic MPEG-1 Layer 2 Encoder in accordance with the present invention;

FIG. 11 shows a Conventional MPEG-1 Layer 2 Decoder for Eureka-1 47 DAB;

FIG. 12 shows a Steganographic MPEG-1 Layer 2 Decoder in accordance with the present invention;

FIG. 13 shows a Block Flow for a Musicam Steganography Algorithm in accordance with the present invention;

FIG. 14 shows two adjacent 8 ms windows, one having a triangular mask applied in which data can be hidden;

FIG. 15 shows different mask shapes which can be used to hide data.

### DETAILED DESCRIPTION

Psychoacoustic Codecs

The audio encoding system used in Eureka-147 digital audio broadcasting is a slightly modified form of ISO 11172-3 MPEG-1 Layer 2 encoding. This is a psychoacoustical (or perceptual) audio codec (PAC), which attempts to compress audio data essentially by discarding information which is inaudible (according to a particular quality target threshold and audience).

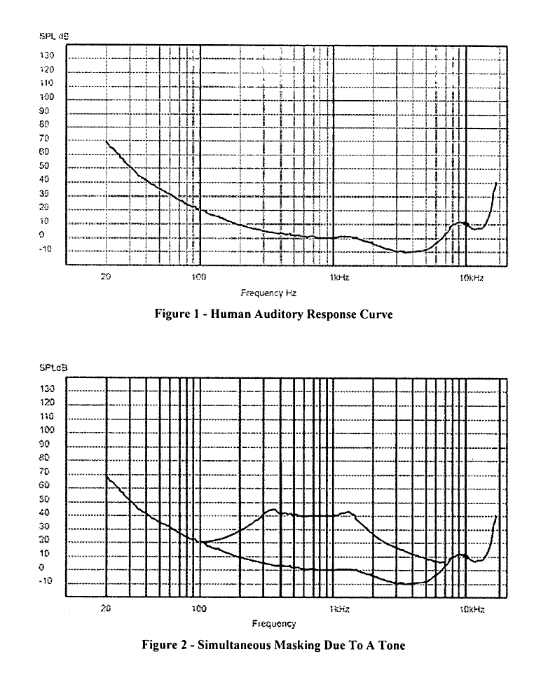

A baseline human auditory response curve is shown in FIG. 1. As may be appreciated, the human ear (or more accurately, ear+brain) is most sensitive in the region between 2 and 5 kHz, around the normal speech bandwidth. As lower and higher frequencies are traversed, the threshold of audibility (measured in SPL dBs) increases dramatically.

Now, this curve is itself of use to a simple PAC, since a default pulse code modulation (PCM) digitised audio signal reproduced through standard equipment will, in general, represent all frequencies with equal precision. Since as many bits would be used for very low frequency bands as the sensitive mid-frequency bands, for example, redundancy clearly exists within the signal. To exploit this redundancy, of course, we need to process the data in frequency, not in time; therefore most PACs will apply some kind of frequency bank filtering to their input data, and it will be the output values from each of these filters that will be quantized (the general form of a PAC is shown in FIG. 5) according to a human auditory response curve.

However, a well-executed PAC will also exploit masking where the ear's response to one component of the presented audio stream masks its normal ability (as represented in FIG. 1) to detect sound. There are two basic classes of masking: simultaneous masking, which operates while the masking audio component (e.g., a tone) is present, and non-simultaneous masking, which occurs either in anticipation of, or following, a masking audio component. Therefore, we say simultaneous masking occurs in the frequency domain, and non-simultaneous masking occurs in the time domain.

Simultaneous masking tends to occur at frequencies close to the frequency of the masking signal, as shown in FIG. 2. In fact, we may distinguish a set of so-called critical bands across the audio spectrum, where a band is defined by the fact that signals within it are masked much more by a tone within it than a tone outside it. The width of these bands differs across the spectrum from 20 Hz to 20 kHz, with the lower-frequency bands being much wider than those at the middle-frequency and high-frequency parts of the spectrum.

A PAC can perform a frequency analysis to determine the presence of masking tones within each of the critical bands, and then apply quantization thresholds appropriately to reduce information yielded effectively redundant by the masking. Note that, since the tone is likely to be transitory, the frequency filter outputs must be split up in the time domain also, into frames, and the PAC treats the frame as a constant state entity for its entire length (in more sophisticated codecs, such as MPEG-1 layer 3 (MP3), the frame length may be shortened in periods of dynamic activity, such as a large orchestral attack, and widened again in periods of lower volatility). Note however that there may be a distinction between the coding frame and the transport frame used within the system, with e.g., many coding frames per transport frame, for example.

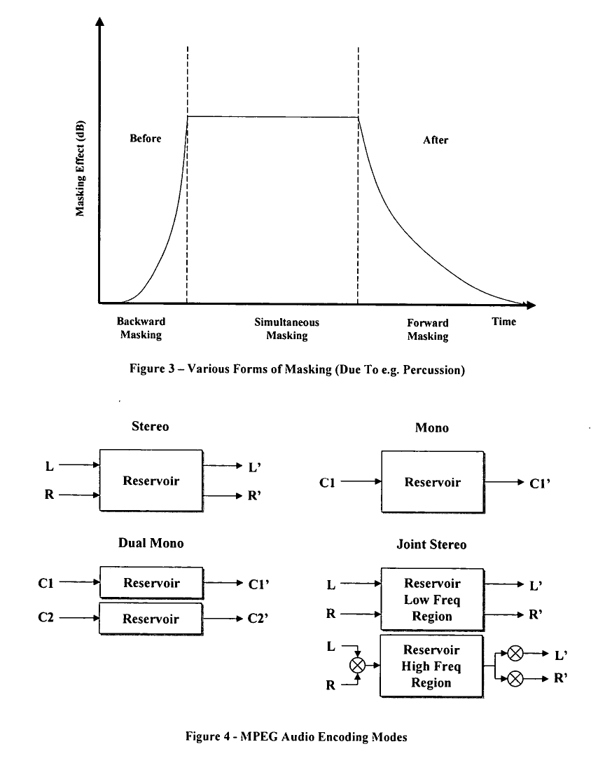

Non-simultaneous masking occurs both for a short period prior to a masking sound (e.g., a percussive beat)—which is known as backward masking, and for a longer period after it has completed, known as forward masking. These effects are shown in FIG. 3. Forward masking may last for up to 100 ms after cessation of the masking signal, and backwards masking may preceed it for up to 5 ms. Non-simultaneous masking occurs because the basilar membrane in the ear takes time to register the presence or absence an incoming stimulus, since it can neither start nor stop vibrating instantaneously.

In summary then, a PAC operates (as shown in outline in FIG. 5) by first splitting the signal up in the frequency domain using a band splitting filter bank, while simultaneously analysing the signal for the presence of maskers within the various critical bands using a psychoacoustic model. The masking threshold curves determined by this model (3 dimensional in time and frequency) are then used to control the quantization of the signals within the bands (and, where used, the selection of the overall dynamic range for the bands through the use of scale factor sets). Because the audio signal has been split up in frequency into bands, the effects of requantization (increased absolute noise levels) are restricted to within the band.

Finally, the encoded, compressed information is framed, which may include the use of lossless compression (e.g., Huffman encoding is used in MP3).

The MPEG Family of Psychoacoustic Codecs

In 1988, the Moving Pictures Experts Group (MPEG) was formed to look into the future of digital video products and to compare and assess the various coding schemes to arrive at an international standard. In the same year, the MPEG Audio group was formed with the same remit applied to digital audio. Members of the MPEG Audio group were also closely associated with the Eureka 147 digital radio project. The result of this work was the publication in 1992 of a standard—ISO 11172—consisting of three parts, dealing with audio, video and systems and is generally termed the MPEG1 standard.

The MPEG1 standard (Audio part) supports sampling rates of 32 kHz, 44.1 kHz, and 48 kHz (a new half-rate standard was also introduced), and output bit rates of 32, 48, 56, 64, 96, 112, 128, 160, 192, 256, 384, 448 kbit/s. The legal encoding modes (as shown in FIG. 4) are single channel mono, dual channel mono, stereo and joint stereo.

In stereo mode, the processed signal is a stereo programme consisting of two channels, the left and the right channel. Generally a common bit reservoir is used for the two channels. When mono coding, the processed signal is a monophonic programme consisting of one channel only. In dual channel mode, the processed signal consists of two independent monophonic programmes that are encoded. Half the total bit-rate is used for each channel. In joint stereo mode, the processed signal is a stereo programme consisting of two channels, the left and the right channel. In the low frequency region the two channels are coded as normal stereo. In the high frequency region only one signal is encoded. At the receiver side a pseudo-stereophonic signal is reconstructed using scaling coefficients. This results in an overall reduction in bit rate.

Defined within the ISO 11172 standard are three possible layers of coding, each with increasing complexity, coding delay and computational loading (but offering, in return, increased compression of the source signal for a particular target audio quality).

Layer 1 is known as simplified Musicam. Layer 2 adds more complexity, and is known as Musicam (with some minor modifications this is the encoding used by the Eureka-147 DAB system). Layer 3 (widely known as MP3) is the most complex of the three, intended initially for telecommunications use (but now with broad general adoption).

Importantly, for all three layers, the ISO standards only define the format of the encoded data stream and the decoding process. Manufacturers may provide their own psychoacoustic models and concomitant encoders. No psychoacoustic models (PAMs) are required by the decoder, whose purpose in life is simply to recover the scale factors and samples from the bit stream and then reconstruct the original PCM audio. However, the standards bodies do provide ‘reference’ code for a baseline encoder, and this code (or functionally equivalent variants of it) are widely used within the digital audio broadcast industry today within commercial Musicam encoders.

The default PAM is not particularly efficient, and the decode-only stipulation of the MPEG standard therefore opens the door for the methodology described herein, where ‘excess’ bits from the standard Musicam are reclaimed and overwritten with steganographic ‘payload’. The technique will be described in more detail below, but it should be noted here that it is distinct from the use of a more efficient PAM, because it utilizes the ‘parametric inertia’ which is necessarily part of encoded MPEG data, whatever the PAM.

ISO Layer 1

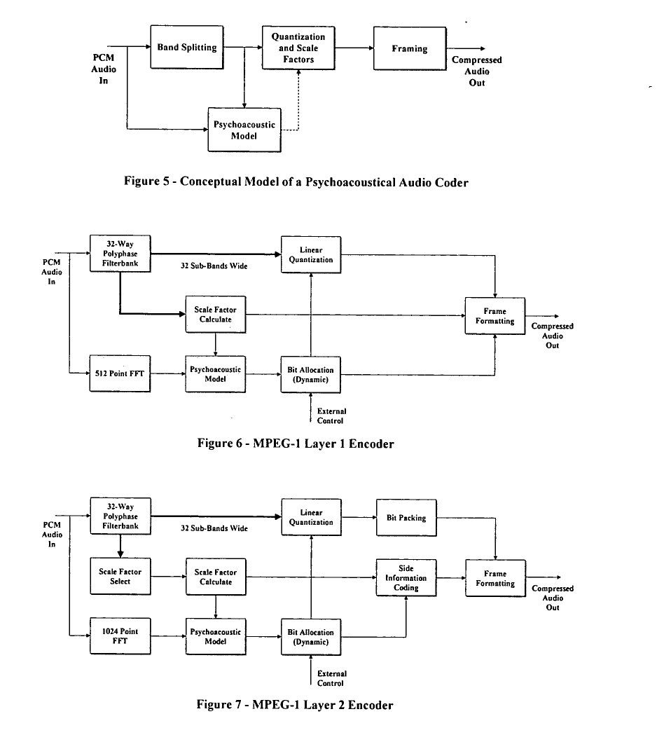

ISO Layer 1 is also known as simplified Musicam. FIG. 6 shows a block diagram of an ISO Layer 1 coder. The incoming PCM samples are divided into 32 equally spaced (750 Hz) sub-bands by a polyphase filter bank. The samples out of each of the filters are grouped into blocks of 12. The sampling rate is 1.5 kHz (twice the polyphase filter frequency bandwidth). The highest amplitude in each 12 sample block is used to calculate the scale factor (exponent). A six bit code is used which gives 64 levels in 2 dB steps, giving an approximate 120 dB dynamic range per sub-band.

In parallel with this process, the PCM samples are subjected to a 512 point FFT (fast Fourier transform), yielding a relatively fine resolution amplitude/phase vs. frequency analysis of the inbound signal. This information is used to derive the masking effect for each sub-band, for each 8 ms block. Once each sub-band's masking effect has been determined, the sub-bands may be allocated a number of bits for a subsequent requantization process. Bit allocation occurs on the basis of a target sound quality. From 0 to 15 bits may be allocated per sub-band.

ISO Layer 2—Musicam

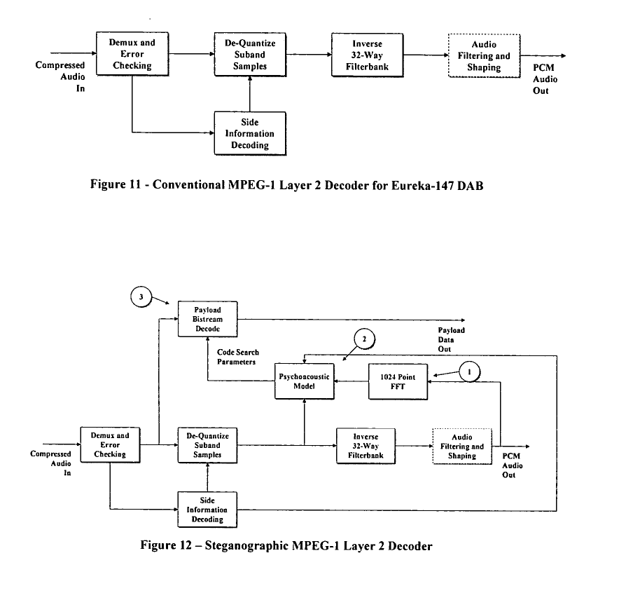

The ISO layer 2 system is known as Musicam. It uses the same polyphase filter bank as the layer 1 system, but the FFT in the PAM chain is increased in size to 1024 points (an 8 ms analysis window is again used). An encoder chain for Musicam is shown in FIG. 7; a decoder (for the slightly modified use of the system within DAB) is shown in FIG. 11.

Scale factor and bit allocation information redundancy is coded in layer 2 to reduce the bit rate. The scale factors for 3, 8 ms blocks (corresponding to one MPEG-1 layer 2 audio frame of 24 ms duration) are grouped and then a scale-factor select tag is used to indicate how they are arranged.

Layer 2 also provides for differing numbers of available quantization levels, with more available for lower frequency components.

The Musicam encoder offers a higher sound quality at lower data rates than layer 1, because it has a more accurate PAM with better quality analysis (provided by the 1024 point FFT) and because scale factors are grouped to obtain maximum reduction in overhead bits.

ISO Layer 3—MP3

The final layer of refinement in coding quality provided by the ISO standard is layer 3—more commonly known as ‘MP3’. Since it is layer 2, not layer 3, that is utilised within the Eureka-147 DAB system, we will not discuss MP3 in depth, other than to note that it has a 512 point MDCT in addition to the 32-way filterbank, to improve resolution; a better PAM, and lossless Huffman coding applied to the output frame.

MPEG Data Framing Format

In layer 1 the framed audio data corresponds to 384 PCM samples, in layer II it corresponds to 1152 PCM samples. Layer 1's frame length is correspondingly 8 ms. Layer II's frame length is 24 ms. The generalised format for the audio frame is shown in FIG. 8. The 32 bit header contains information about synchronisation, which layer, bit rates, sampling rates, mode and pre-emphasis. This is followed by a 16 bit cyclic redundancy check (CRC) code. The audio data is followed by ancillary data.

The information is formatted slightly differently between the layer 1 and layer 2 frames, but both contain bit allocation information, scale factors, and the sub-band samples themselves. For layer 2, the bit allocation data comes first followed by the scale factor select information (ScFSI) which is transmitted in a group for three sets of 12 samples, followed by the scale factors themselves and the sub band samples. In layer 2, the frame length is 24 ms.

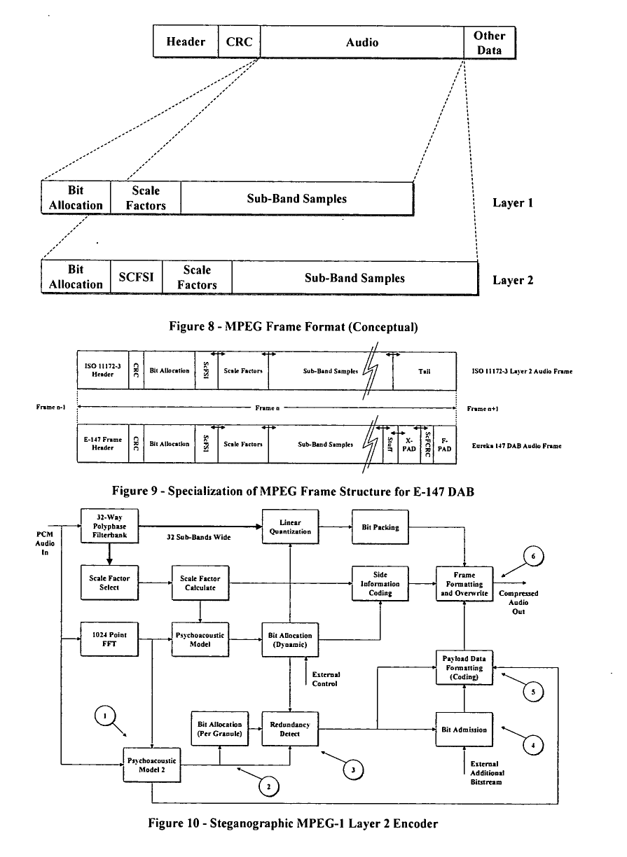

FIG. 9 shows how the frame format is modified for use with Eureka-147 digital audio broadcasting. The header is slightly modified, and more structure is given to the ancillary data (including, importantly, a CRC for the scale factor information).

Steganography

The concepts of steganography—data hiding—are described in the prior art, and a reasonable review of modern methods is provided in the text Information Hiding Techniques for Steganography and Digital Watermarking, Katzenbeisser, S. & Fabien, A. P. Petitcolas (Eds.), January 2000, Artech House.

In the application described here, we exploit the inherent redundancy due to ‘parametric inertia’ of the frame-based MPEG audio encoder in DAB to allow an additional payload message to be inserted. The ‘hidden’ nature of the inserted data ensures that the carrier message (in this case, an original Musicam digital audio broadcast stream) may still be played by legacy receivers without any special processing (although they will be unable to extract the ‘hidden’ message, of course). In contrast, and as described below, appropriately modified receivers will be able to extract the additional payload message. By enabling broadcasters effectively to increase the data bandwidth of a DAB signal, without reducing perceived quality or modifying the compound characteristics of the signal sent to air, this system can provide broadcasters with significant commercial benefits.

Applying Steganographic Techniques to Musicam Frames

A conventional layer-1 encoder is shown in FIG. 6. To recap, inbound audio is passed through a 32-way polyphase filter, before being quantized (for 8 ms packet lengths). A 512 point analysis is performed to inform the PAM of the spectral breakdown of the signal, and this allows the allocation of bits for the quantizer. Scale factors are also calculated as a side chain function. In the final stage the scale factors, quantized samples and bit allocation information, together with CRCs etc, are formatted into a single 8 ms frame.

It is similar with the layer-2 (Musicam) encoder shown in FIG. 7, except that a finer grain FFT is used (together with a more sophisticated PAM and the scale factor information redundancy is reduced. A Musicam frame is 24 ms long consisting of 3 internal 8 ms analysis windows.

Increasing the Data Capacity of Musicam

Clearly, the MPEG encoder is relatively efficient within its 8 ms frame boundaries, and provides a reasonably flexible basis for the addition of a more efficient PAM, as only the bitstream format and decoder architecture is specified.

The feature of MPEG (and specifically, Musicam) that we exploit in the steganographic system described here, is that every 8 ms window has, for each of the 32 sub-bands, a fixed ‘resolution’, which is a combination of the scale factor and bit allocation for that 8 ms window. This represents the potential ‘smallest step’ or quantum for that frequency band for that time step. We can write:

$$\begin{matrix}Resolution ( MP2Frame8msPart p ) = \frac{1}{{2}^{NumOfBitsPerSample ( p )}} * \\ ScaleFactorValue ( p )\end{matrix}$$

Then, it is possible to produce an encoder that looks at the specified resolution for each sub-band for each 8 ms part and exploits the redundancy caused by the frame-constant parameterisation assumption of MPEG coding.

A very general way to do this, for example, would be to re-compress the target PCM stream using the original Musicam encoder, but offset by up to half an 8 ms frame in either direction, quantized by the length of time represented by a single ‘granule’. All possible allocated resolutions for a specific temporal sample (one ‘granule’ of time) are compared and the most permissive used as the ‘assumed minimum requirement’ (AMR).

The floor (log2(AMR resolution/actual resolution)) for this granule is then calculated for each temporal sample, and, if this is >0, redundant bits are deemed to exist and may be overwritten.

The problem with this sort of general scheme is the additional complexity it would entail for the concomitant decoder, as the latter would have to independently infer which samples were ‘over-resolved’ by at least one bit and so carried payload data. Solutions to this are possible—such as for example mapping the data back to PCM and then going through a similar recoding process, varying the sample offsets to find the AMR for each sample; however, the Musicam frame having been modified by the steganographic insertion, and in any case with the additional impact of the reconstruction filters, this process may not yield the same AMR values as the original source-side encoder. This problem may be addressed, for example through the use of a convolutional code overlay on the payload sequence, but involve relatively complex processing (and hence, potentially, expense) at the receiver side.

FIG. 10 shows the encoding process for a steganographic Musicam encoder. A second parallel psychoacoustic model (1) to the main PAM is used to generate a bit allocation (2) which is then compared with the actual granule bit allocation (3); any excess bits are used to gate the entry of new payload bits through the admission control subsystem (4) which are placed into the LSBs of the affected granules by the data formatting (5).

Note that since only the granules are modified by this encoder no CRCs need to be recomputed.

On the receiver, FIG. 12 shows how the output data can be fed through an optional analysis FFT (1) and a PAM (taking both input from the FFT and the Musicam bitstream itself (2) to generate data about where the bits are likely to have been inserted, and this data controls a payload extractor (3) which pulls out the inserted steganographic bitstream from the granule data.

Sample Embodiment

An alternative, simpler embodiment is simply to assume that the resolutions, where they vary from 8 ms block to 8 ms block, do not move immediately and ‘magically’ at the boundary, but rather vary smoothly between the two values. Assuming, for example, a ‘triangular’ ramp between the resolutions, we would then be able to calculate the sliding ‘actual resolution estimate’ for each sample; and, where this allowed at least one bit of leeway, the excess space could be utilised for coding.

There are 12 samples in each block. Suppose, for example, that the resolution on the first 8 ms block was ‘2’, and in the second was ‘16’; then under the triangular encoding rule we would have originally:

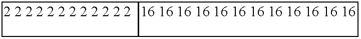

Then applying the ‘triangle rule’ we would have assumed blended actual resolutions of (rounding):

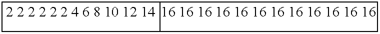

The above two tables contain the resolution of each sample of two contiguous 8 ms blocks.

The following table contains the number of redundant bits of each sample of two contiguous 8 ms blocks. The number of redundant bits has been calculated as follows:

$$\begin{matrix}NumRedundantBits = Floor ( OrigBitAlloc - SmoothedBitAlloc ) \\ = Floor ( {log}_{2} \frac{SCF}{OrigResol} - {log}_{2} \frac{SCF}{SmoothedRes} ) \\ = Floor ( {log}_{2} \frac{SmoothedRes}{OrigResol} )\end{matrix}$$

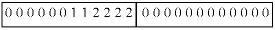

These bits are eligible to be overwritten (i.e., the LSBs of the mantissa data in the granules can be overwritten safely by the steganographic encoder).

Note that a major benefit of this encoder is that it is very fast in operation both in the encoder and decoder (and requires, on the decode side, no processing of the output audio bitstream—so no FFT as in (1) on FIG. 12 is required). Processing on the receiver side is also deterministic. Furthermore, since only granule bits have been modified, the encoder does not need to change any of the MPEG frame CRCs.

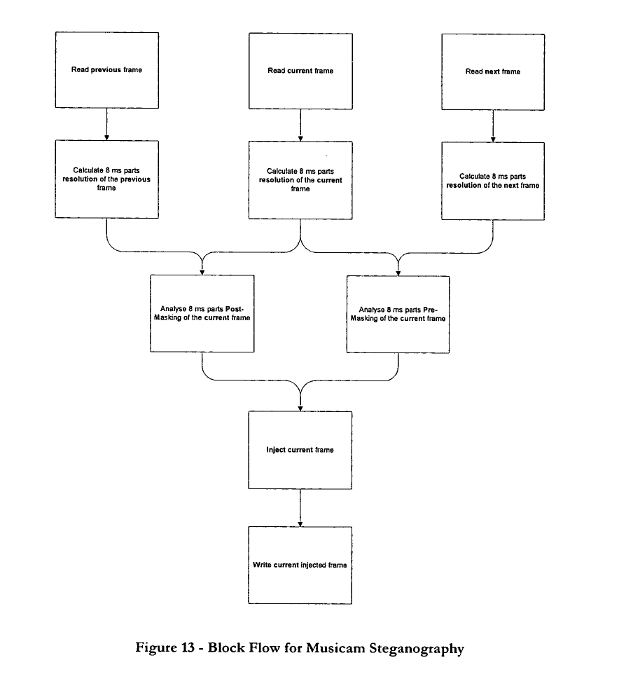

This process may also be applied in the opposite direction, when the resolution is increasing (i.e. the minimum step is decreasing in size). The overall approach is shown in FIG. 13, and simple pseudo-code is given in Appendix 1.

It is possible to experiment with the length and the shape of the pre and post masking areas (i.e. not use a simple ramp as described above) and with parameters in the decision algorithm that determines whether masking is occurring and in the algorithm that decides how masking occurs. In each case, the function is applied to only one half of a 8 ms window to ensure a smooth transition (the function could also start at different places within a window).

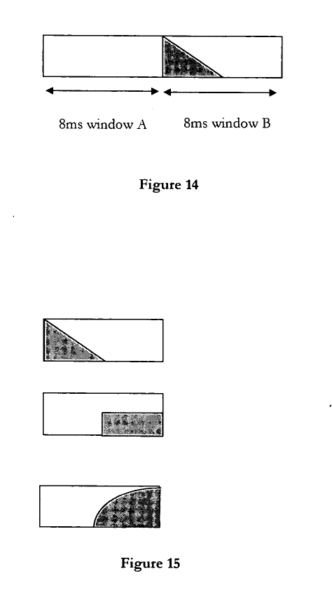

In FIG. 14, 8 ms window B has, using the conventional Musicam psychoacoustic model, a fixed resolution which is higher than the fixed resolution of 8 ms window A. Because the final samples in window A are likely to have a ‘true’ resolution close to the ‘true’ resolution of samples at the start of window B, one can infer that the first samples in window B are probably being allocated too many bits (i.e. have too fine a resolution) and can hence have their resolution reduced. A downward ramp is therefore imposed on the first half of the window B. The shaded triangular mask area is indicative of bits in window B which can be overwritten with the data payload.

An upward ramp could be applied where the next window has a much lower fixed resolution than the fixed resolution of a given window, indicating that the second half of the given window probably has been allocated too fine a resolution and can hence carry a data payload. Some simple mask shapes (including the ramp) are shown in FIG. 15.

Algorithm Parameterisation

A more detailed analysis of the algorithm allows one to identify parts of the algorithm that can be parameterised; the following potential parameters have been identified:

Let A, B, C be three 8 ms consecutive parts of an MP2 audio stream:

PRE-Masking_Enabled: [true,false]

PRE_Masking_Resolution_Ratio: [0.0, 1.0]; actual sensible range and granularity to be investigated.

Used in the decision algorithm that determines whether masking is occurring: masking occurs if

Resolution(A)<Resolution(B)*PRE_Masking_Resolution_Ratio

PRE_Masking_Resolution_Ratio represents a percentage and a typical value could be 0.9, i.e. 90%.

PRE_Masking_Bit_Alloc_Ratio: [0.0, 1.0]; actual sensible range and granularity to be investigated.

Used in the decision algorithm that determines how masking is occurring: the new audio bit allocation value where masking occurs can be obtained expanding the following expression:

Resolution(A_{NearB})=Resolution(B)*PRE_Masking_BitAlloc_Ratio

PRE_Masking_Bit_Alloc_Ratio represents a percentage and a typical value could be 0.9, i.e. 90%.

PRE_Masking_Ramp_Length: [1, 12]

It represents the length of the masking area and it is measured in samples.

PRE_Masking_Ramp_Shape: [flat, triangular, . . . ]

It represents the shape of the masking area.

POST-Masking_Enabled

POST_Masking_Resolution_Ratio: [0.0, 1.0]; actual sensible range and granularity to be investigated.

Used in the decision algorithm that determines whether masking is occurring: masking occurs if

Resolution(B)<Resolution(A)*POST Masking_Resolution_Ratio

POST_Masking_Resolution_Ratio represents a percentage and a typical value could be 0.9, i.e. 90%.

POST_Masking_Bit_Alloc_Ratio: [0.0, 1.0]; actual sensible range and granularity to be investigated.

Used in the decision algorithm that determines how masking is occurring the new audio bit allocation value where masking occurs can be obtained expanding the following expression:

Resolution(B_{NearA})=Resolution(A)*POST_Masking_BitAlloc_Ratio

POST_Masking_Bit_Alloc_Ratio represents a percentage and a typical value could be 0.9, i.e. 90%.

POST_Masking_Ramp_Length: [1,12]

It represents the length of the masking area and it is measured in samples.

POST_Masking_Ramp_Shape: [flat, triangular, . . . ]

It represents the shape of the masking area.

HiddenData_BitAlloc_Overlapping_Mode: [Min, Max, Average, . . . ]

If both PRE and POST-Masking are enabled, the areas allocated for hidden data for the two masking can overlap. In this case different strategies can be adopted;

for every sample where an overlapping occurs, consider the bit allocation for hidden data to be the min/max/average/op of the individual bit allocation due to PRE and POST masking.

Follows the pseudocode of the algorithm modified to use the previous parameters.

Parameters Encoding

The extraction algorithm used on the receiver side, to be able to extract the hidden data, must match the injection algorithm used in the transmission side. This means that the parameters used must be the same; the receiver must then know the parameters used in on the transmission side. One solution is to transmit the parameters used in every frame; the problem is that if not encoded, the amount of space needed to transmit the parameters would easily overcome the amount of space available in the hidden data channel. An improvement is achievable encoding the parameters in the same fashion as the mpeg frame header codes the information pertaining to the frame content. To this end though, it is necessary establish a reasonable range and granularity for the parameters. Some experimentation allows one to find which are reasonable values a parameter can assume and to exclude large parts of the full range of values.

Another problem to solve is how to transmit the parameters to the receiver; the following issues need to be addressed:

It is not possible to transmit the parameters for frame f in the hidden data channel of f: they must be known beforehand.

It is probably impossible to transmit the parameters for frame fᵢ in the hidden data channel of the frame fᵢ₋₁: there is no guarantee that fᵢ₋ₜ can contain hidden data.

Appendix 1

MP2 Data Hiding Algorithm

S=“stream of MP2 frames fᵢ”

D=“stream of data to be hidden in the MP2 frames”

HiddenDataBitAllocation(fᵢ)=“number of bits allocated for hidden data for every sample of the frame fᵢ”

// Takes as input a stream of MP2 frames S and a stream of data D and injects the
frames of S with data contained in D
function HideData(S, D)
{

for all fᵢ ε S
{

DecodeFrameUpUntilScaleFactors(fᵢ₋₁);
DecodeFrameUpUntilScaleFactors(fᵢ);
DecodeFrameUpUntilScaleFactors(fᵢ₊₁);
// hidden data analysis for frame fᵢ
HiddenDataAnalysis(fᵢ, HiddenDataBitAllocation(fᵢ), fᵢ₋₁, fᵢ₊₁);
// hide data in frame fᵢ
HideData(fᵢ, HiddenDataBitAllocation(fᵢ), D);

}

}
// Decodes header, bit allocation and scale factors of an MP2 frame f
// For a description see ISO/IEC 11172-3 Layer II, ISO/IEG 13818-3 Layer II, ETC
300 401-7
function DecodeFrameUpUntilScaleFactors(f)
// Takes as input three conscutive mp2 frames fᵢ₋₁, fᵢ, fᵢ₊₁ and analyses the possible
redundancies in the resolution of the samples of fᵢ.
// If any sample result to have too fine a resolution, fill HiddenDataBitAllocation(fᵢ)
with the number of redundant bits for every sample;
// it's then possible to overwrite the samples' redundant LSB bits with data.
// OUTPUT: HiddenDataBitAllocation(fᵢ)
//
function HiddenDataAnalysis(fᵢ, HiddenDataBitAllocation(fᵢ), fᵢ₋₁, fᵢ₊₁)
{

NumChannels = “number of channel of the frame (i.e. 1 if mode == ‘mono’; 2
otherwise)”
for channel = 1 to NumChannels
{

NumSubBands = “number of subbands of the frame”
for subband = 1 to NumSubBands
{

NumParts = “number of 8 millisecond parts of an MP2 frame (i.e 3)”;
for part = 1 to NumParts
{

Resolution(fᵢ₋₁, channel, subband, part) = CalcResolution(
NumOfAudioBitsPerSample(fᵢ₋₁, channel, subband),

ScaleFactorValue(fᵢ₋₁, channel, subband, part) );

Resolution(fᵢ, channel, subband, part) = CalcResolution(
NumOfAudioBitsPerSample (fᵢ, channel, subband),

ScaleFactorValue(fᵢ, channel, subband, part) );

Resolution(fᵢ₊₁, channel, subband, part) = CalcResolution(
NumOfAudioBitsPerSample (fᵢ₊₁, channel, subband),

ScaleFactorValue(fᵢ₊₁, channel, subband, part) );

// analyse PRE-Masking of frame fᵢ

if(part < 3)
{

if(Resolution(fᵢ, channel, subband, part) < Resolution(fᵢ, channel,
subband, part + 1) )
{

TargetNumOfAudioBitsPerSampleAtEndOfPart(fᵢ, channel, subband,
part) =

CalcTargetNumOfAudioBitsPerSample(ScaleFactorValue(fᵢ,

channel, subband, part+1),
NumOfAudioBitsPerSample(fᵢ, channel, subband),

ScaleFactorValue(fᵢ,

channel, subband, part) );

}

}
else // part == 3
{

if(Resolution(fᵢ, channel, subband, part) < Resolution(fᵢ₊₁, channel,
subband, 1) )
{

TargetNumOfAudioBitsPerSampleAtEndOfPart(fᵢ, channel, subband,
part) =

CalcTargetNumOfAudioBitsPerSample(ScaleFactorValue(fᵢ₊₁,

channel, subband, 1),
NumOfAudioBitsPerSample (fᵢ₊₁, channel, subband),

ScaleFactorValue(fᵢ,

channel, subband, part) );

}

}
// sets HiddenDataBitAllocation(fᵢ, channel, subband, part)
CalculateHiddenDataBits(NumOfAudioBitsPerSample (fᵢ, channel,
subband),
TargetNumOfAudioBitsPerSampleAtEndOfPart(fᵢ, channel, subband, part
),

HiddenDataBitAllocation(fᵢ,

channel, subband, part) );
// analyse POST-Masking of frame fᵢ
if(part > 1)
{

if(Resolution(fᵢ, channel, subband, part−1) > Resolution(fᵢ, channel,
subband, part) )
{

TargetNumOfAudioBitsPerSampleAtStartOfPart(fᵢ, channel,
subband, part) =

CalcTargetNumOfAudioBitsPerSample(ScaleFactorValue(fᵢ,

channel, subband, part-1),
NumOfAudioBitsPerSample(fᵢ, channel, subband),

ScaleFactorValue(f_{i,}

channel, subband, part) );

}

}
else // part == 1
{

if(Resolution(fᵢ₊₁, channel, subband, 3) > Resolution(fᵢ, channel,
subband, part) )
{

TargetNumOfAudioBitsPerSampleAtEndOfPart(fᵢ, channel, subband,
part) =

CalcTargetNumOfAudioBitsPerSample(ScaleFactorValue(fᵢ₋₁,

channel, subband, 3),
NumOfAudioBirsPerSample(fᵢ₋₁, channel, subband),

ScaleFactorValue(fᵢ,

channel, subband, part) );

}

}
// sets HiddenDataBitAllocation(fᵢ, channel, subband, part)
CalculateHiddenDataBits(
TargetNumOfAudioBitsPerSampleAtStartOfPart(fᵢ, channel, subband, part

NumOfAudioBitsPerSample (fᵢ,

channel, subband),

HiddenDataBitAllocation(fᵢ,

channel, subband, part) );

}

}

}

}
// Takes as input the bit allocation of a sample and its scale factor and calculates the
resolution of the sample.
//
function CalcResolution( NumOfAudioBitsPerSample, ScaleFactorValue)
{

$return \frac{1}{{2}^{NumOfAudioBitsPerSample}} * ScaleFactorValue ;$

}
// Takes as input the bit allocation of a sample A, its SCF and the SCF of another
sample B and
// calculates the bit allocation to apply to B so that A and B have the same resolution.
//
function CalcTargetNumOfAudioBitsPerSample(ScaleFactorValue_A,
NumOfAudioBitsPerSample_A, ScaleFactorValue_B)
{

return log2( (ScaleFactorValue_B/ScaleFactorValue_A) * 2\hat{ }
NumOfAudioBitsPerSample_A);

}
// Given the target number of audio bits at the start and at the end of a frame part,
// decides how many bits to allocate for hidden data for each sample of the part.
// It sets PartNumOfHiddenDataBitsPerSample.
// Different allocation strategies (flat, triangle, . . . ) can be implemented;
// the strategy presented here allocates the same number of bits (flat) to the half of the
part
// near the boundary whose NumOfAudioBitsPerSample is lower.
//
function CalculateHiddenDataBits(TargetNumOfAudioBitsPerSampleAtStartOfPart,

TargetNumOfAudioBitsPerSampleAtEndOfPart,
PartNumOfHiddenDataBitsPerSample)

{

NUM_SAMPLES_PER_PART = 12;
if(TargetNumOfAudioBitsPerSampleAtStartOfPart <
TargetNumOfAudioBitsPerSampleAtEndOfPart)
{

// allocate space for hidden data in the first half of the part
for sample = 1 to NUM_SAMPLES_PER_PART/2
{

PartNumOfHiddenDataBitsPerSample[sample] = floor(
TargetNumOfAudioBitsPerSampleAtEndOfPart −

TargetNumOfAudioBitsPerSampleAtStart
OfPart);

}

}
if(TargetNumOfAudioBitsPerSampleAtStartOfPart >
TargetNumOfAudioBitsPerSampleAtEndOfPart)
{

// allocate space for hidden data in the second half of the part
for sample = NUM_SAMPLES_PER_PART/2 to
NUM_SAMPLES_PER_PART
{

PartNumOfHiddenDataBitsPerSample[sample] = floor(
TargetNumOfAudioBitsPerSampleAtStartOfPart −

TargetNumOfAudioBitsPerSampleAtEndOfPart );

}

}

}
// Take as input HiddenDataBitAllocation(f) that store the number n of redundant bits
for every sample of f
// and overwrite the corresponding sample LSBs with n bits of data taken from D.
//
function HideData(f, HiddenDataBitAllocation(f), D)
{

NumChannels = “number of channel of the frame (i.e. 1 if mode == ‘mono’; 2
otherwise)”
for channel = 1 to NumChannels
{

NumSubBands = “number of subbands of the frame”
for subband = 1 to NumSubBands
{

NumParts = “number of 8 millisecond parts of an MP2 frame (i.e 3)”;
for part = 1 to NumParts
{

for sample = 1 to NUM_SAMPLES_PER_PART
{

NumBitsToHideInSample = HiddenDataBitAllocation(f, channel,

subband, part, sample);

OverwriteSampleLSB(CodedFrameSample(f, channel, subband, part,
sample),

D.GetNextBits(

NumBitsToHideInSample),

NumBitsToHideInSample);

}

}

}

}

1. An encoder programmed to add a data payload to a compressed digital audio frame, in which parameters that determine the resolution of frame sub-band samples are constant across a window of a given number of samples but may be different for adjacent windows;
characterised in that the encoder is further programmed to apply a sub-band resolution algorithm that generates a more accurate set of resolution parameters that vary across at least part of a given window, the difference between the constant parameters and the variable resolution parameters for the same window being indicative of bits which can be overwritten with the data payload.

2. The encoder of claim 1 in which the format of the compressed digital audio frame is MPEG 1 layer II.

3. The encoder of claim 1 in which resolution is a function of the scale factor and bit allocation for the samples in the window.

4. The encoder of claim 3 in which each window is a 8 ms window formed from a group of 12 samples and constitutes a granule and three such windows form each frame.

5. The encoder of claim 4 in which resolution is defined by the following:
$$\begin{matrix}Resolution ( MP2Frame8msPart p ) = \frac{1}{{2}^{NumOfBitsPerSample ( p )}} * \\ ScaleFactorValue ( p )\end{matrix}$$

6. The encoder of claim 1 in which the sub-band resolution algorithm is designed to model a smooth transition between the constant resolution values of two adjacent windows generated by the pyschoacoustic model.

7. The encoder of claim 1 in which the algorithm generates a shape approximating to a triangle, trapezoid, rectangle, or portion of an ellipse and the region within the shape is indicative of bits which can be overwritten with the data payload.

8. The encoder of claim 7 in which the bits that can be overwritten to carry the payload occupy all or less of a window.

9. A decoder programmed to extract a data payload from a compressed digital audio frame, which has been added to the frame with the encoder of claim 1, in which the decoder is programmed to apply an algorithm to identify the bits containing the payload, the algorithm being the same as the sub-band resolution algorithm applied by the encoder.

10. The decoder of claim 9 in which the format of the compressed digital audio frame is MPEG 1 layer II.

11. The decoder of claim 9 in which resolution is a function of the scale factor and bit allocation for the samples in the window.

12. The decoder of claim 11 in which each window is a 8 ms window formed from a group of 12 samples and constitutes a granule and three such windows form each frame.

13. The decoder of claim 12 in which resolution is defined by the following:
$$\begin{matrix}Resolution ( MP2Frame8msPart p ) = \frac{1}{{2}^{NumOfBitsPerSample ( p )}} * \\ ScaleFactorValue ( p )\end{matrix}$$

14. The decoder of claim 9 in which the sub-band resolution algorithm is designed to model a smooth transition between the constant resolution values of two adjacent windows generated by the pyschoacoustic model.

15. The decoder of claim 9 in which the algorithm generates a shape approximating to a triangle, trapezoid, rectangle, or portion of an ellipse and the region within the shape is indicative of bits containing the data payload to be extracted.

16. The decoder of claim 15 in which the bits containing the payload occupy all or less of a window.
